(19) United States
(12) Patent Application Publication
(10) Pub. No.: US 2005/0207271 A1
(43) Pub. Date: Sep. 22, 2005

(54) Twisted stir-stick for food mixer

(75) Inventor: Brian K. Beesley, Sandy, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Back to Basics Products, Inc.

(21) Appl. No.: 10/805,174

(22) Filed: Mar. 19, 2004

(51) Int. Cl. B01F 7/00; B01F 13/00

(52) U.S. Cl. 366/206; 366/343

(57) ABSTRACT

A stir-stick configured for use with a food mixer has a handle configured to be gripped by a user and an elongated stem. The stem defines a stirring portion and has a longitudinal axis and an oblong cross-sectional shape. The stem extends along the longitudinal axis, and outwardly from the longitudinal axis, such that the longitudinal axis is substantially within the stem. The stem extends through a twist that twists from an upper portion to a lower portion, so that an upper cross-sectional shape and a lower cross-sectional shape have different rotational orientations about the longitudinal axis with respect to one another.

### BACKGROUND OF THE INVENTION

1. Field of the Invention

The present invention relates generally to blenders, food or beverage mixers, smoothie makers and the like. More particularly, the present invention relates to twisted stir-stick for such blenders or mixers.

2. Related Art

Blenders or mixers typically have a rotating blade assembly disposed in the bottom of a goblet. The rotating blades mix and/or chop food items or liquid placed inside the goblet. The rotating motion of the blades often imparts a rotational movement to the food items or liquid in the goblet. In addition, a vortex motion can be imparted to the food items or liquid.

One difficulty with blenders is incomplete mixing or processing. For example, some food items can become suspended in the mixture without moving towards the blades. As another example, thicker mixes, such as milk shakes or smoothies, can become static or resist movement. In particular, thicker mixes can clog or stall the blender.

Various solutions have been utilized to facilitate mixing, including ribs protruding from the inside of the goblet, and stir-sticks extending into the goblet. Improving mixing or processing is an ongoing quest.

### SUMMARY OF THE INVENTION

It has been recognized that it would be advantageous to develop an improved stir stick to improve mixing or blending abilities.

The invention provides a twisted stir stick for use with a food mixer. The stir stick includes a handle to be gripped by a user, and an elongated stem. The stem is coupled to the handle and defines a stirring portion. The stirring portion has a longitudinal axis and an oblong cross-sectional shape. The stem extends along the longitudinal axis and outwardly from the longitudinal axis, such that the longitudinal axis is substantially within the stem. In addition, the stem extends through a twist that twists from an upper portion to a lower portion. An upper cross-sectional shape and a lower cross-sectional shape have different rotational orientations about the longitudinal axis with respect to one another.

In accordance with a more detailed aspect of the present invention, the twist is continuous and uninterrupted from the upper portion to the lower portion. The upper and the lower cross-sectional shapes can be oriented at about 90 degrees about the longitudinal axis with respect to one another. The upper and lower portions can define planes oriented transverse with respect to one another, and intersecting one another at the longitudinal axis. The longitudinal axis of the stem can be disposed substantially at a center of the stem, while the twist has a twist axis about which the stem twists. The longitudinal axis and twist axis can be collinear.

In accordance with another more detailed aspect of the present invention, the stir stick can include an enlarged stopper disposed between the handle and the stem to abut a lid of the food mixer. The enlarged stopper can have a downward facing curved face to pivot in an opening in the lid of the food mixer.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a twisted stir stick in accordance with an embodiment of the present invention;

FIG. 2 is a bottom view of the stir stick of FIG. 1;

FIGS. 3 and 4 are side views of the stir stick of FIG. 1;

FIG. 5 is a schematic bottom view of the stir stick of FIG. 1;

FIG. 6 is a side view of the stir stick of FIG. 1 in a food mixer in accordance with an embodiment of the present invention;

FIG. 7 is a partial side view of another stir stick in accordance with an embodiment of the present invention;

FIG. 8 is a schematic view of an operation of the stir stick of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

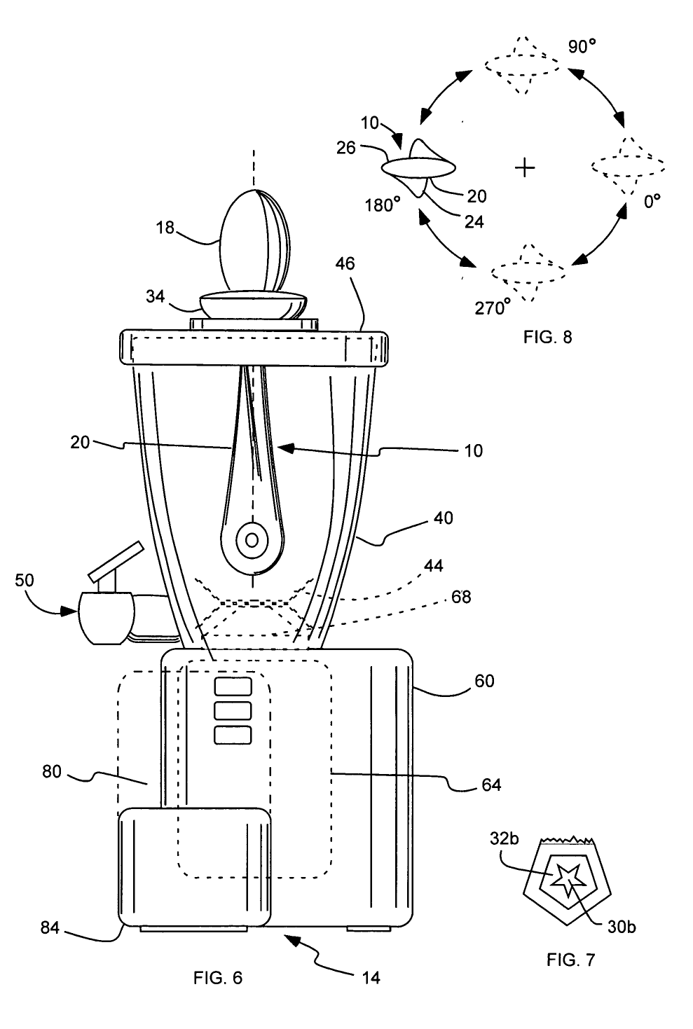

As illustrated in FIGS. 14, a stir stick or stir stick device, indicated generally at 10, in accordance with the present invention is shown for use with a food mixer or food mixer device, indicated generally at 14 (FIG. 6). The term “food mixer” is used broadly herein to refer to food mixers, beverage mixers, blenders, smoothie makers, and the like that mix or blend food and/or liquid. Smoothies are one example of a food or beverage that can be made by mixing or blending smoothie ingredients, such as ice, fruit, etc., with the mixer. The stir stick 10 can be used to facilitate mixing or blending of food and/or liquid to be mixed or blended into a food or beverage. The stir stick 10 advantageously can be twisted, as described below, to facilitate mixing or blending.

The stir stick 10 can include a handle 18 to be gripped by a user, and an elongated stem 20 coupled to the handle and defining a stirring portion. The stir stick, or the handle and stem, can have or define a longitudinal axis 22 along which the handle and stem extend. The handle 18 can be bulbous to fit comfortably in the user's hand. The handle can also be elongated to extend across the user's hand in a comfortable manner. The user can grip the handle to manipulate the stir stick during use.

The stem 20 and stirring portion can be elongated to stir food and/or liquid. As stated above, the stem 20 extends along the longitudinal axis 22, and outwardly from the longitudinal axis, so that the longitudinal axis extends substantially within the stem, or within a perimeter defined by the stem. Thus, the stem 20 is generally straight, or extends along the longitudinal axis. In one aspect, the longitudinal axis 22 can be located substantially at the center of the stem 20.

In addition, the stem 20 can have an oblong cross-sectional shape, having a longer dimension in one direction, and a shorter dimension in another direction, such as an orthogonal direction. The cross-sectional shape is taken or oriented orthogonally, or perpendicularly, to the longitudinal axis. Thus, the stem 20 has a broad face, or broad front and rear faces, and narrow edges or sides. The broad face(s) provides a greater surface area for displacing or acting against food and/or liquid in the mixer, while the sides provide a lesser surface are to facilitate movement of the stem or stirring portion through the food and/or liquid. Such a configuration of the stirring portion allows the stirring portion to provide an uneven mixing action as the stirring portion is moved or rotated. It is believed that the uneven mixing action is more efficient. The oblong cross-sectional shape can be oval, with rounded ends or corners. Thus, the broad face(s) can have a broad convex surface, while the ends have a sharper convex surface. The curvature of the convex surfaces can facilitate the flow of food and/or liquid around the stem as the stir stick moves.

In addition, the stem 20 or stirring portion advantageously is twisted, or extends through a twist. The twist twists, turns or rotates from an upper portion 24 to a lower portion 26 as the stem 20 extends along the longitudinal axis. The twist can be continuous and uninterrupted from the upper portion to the lower portion. In addition, the twist can twist about a twist axis that can be substantially collinear with the longitudinal axis.

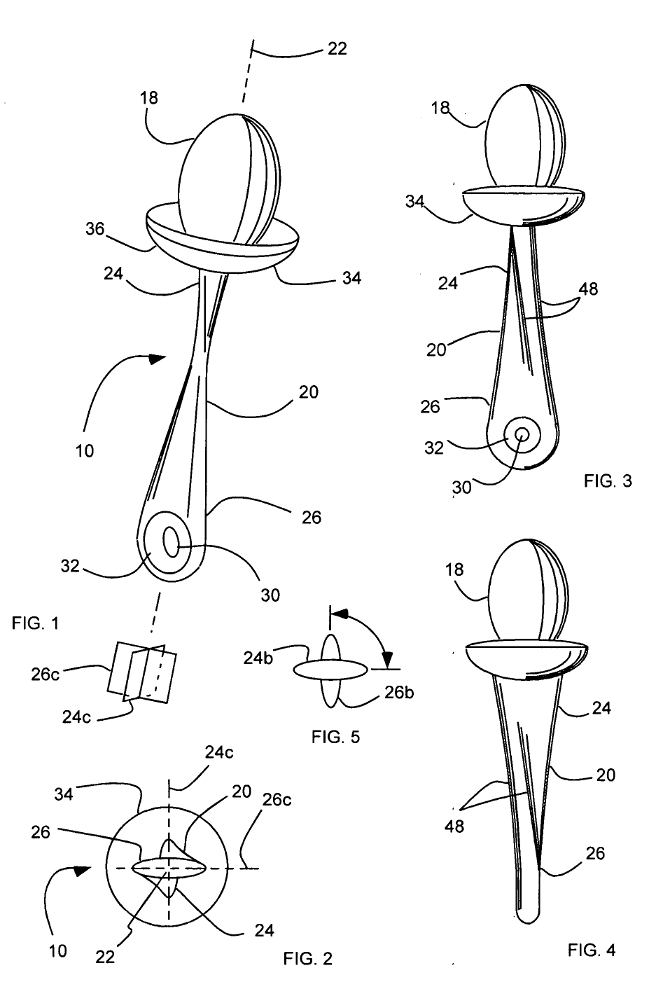

The upper portion 24 has an upper cross-sectional shape (represented by 24b in FIG. 5), and the lower portion 26 has a lower cross-sectional shape (represented by 26b in FIG. 5). Again, the cross-sectional shapes are taken or oriented orthogonal or perpendicular to the longitudinal axis. The upper and lower cross-sectional shapes have different rotational orientations about the longitudinal axis with respect to one another, as best seen in FIGS. 2 and 5. In one aspect, the upper and the lower cross-sectional shapes 24b and 26b are oriented at about 90 degrees, or orthogonally, with respect to one another about the longitudinal axis. In addition, the upper and lower portions 24 and 26 can define planes (represented by 24c and 26c in FIGS. 1 and 2) oriented transverse with respect to one another and intersecting one another at the longitudinal axis.

The stem 20 or stirring portion also can include one or more apertures 30 formed through the stir stick. For example, an aperture 30 can be positioned at a distal or lower end (opposite the handle) of the stem 10. The aperture 30 can allow food and/or liquid to pass through the stem as the stem is moved. Thus, a portion of the food and/or liquid around the apertures is moved as the stem moves, while another portion of the food and/or liquid passes through the aperture, thus mixing the food and/or liquid. A portion of the stem surrounding the aperture can be curved or angled inwardly towards the aperture, similar to a countersink or relief, thus facilitating flow of the food and/or liquid through the aperture. The aperture 30 can be provided in an insert 32 disposed in the stem. The inert 32 and the aperture 30 can have various different shapes. For example, the insert 32b can have a pentagram shape, and the aperture 30b can have a star shape, as shown in FIG. 7. The shape of the insert and aperture can be sized and shaped to facilitate or optimize mixing, or configured for a particular food or liquid to be mixed.

An enlarged stopper 34 can be formed on the stir stick 10, and disposed between the handle 18 and the stem 20 to abut a lid of the food mixer, as described below. Thus, the stopper 34 can rest on the lid during use so that the lid carries the stir stick. The enlarged stopper 34 can have a downward facing curved face 36 or surface capable of pivots in an opening in the lid of the food mixer, as described below. The face 36 or surface can have a semi-bulbous, a substantially semi-spherical, or ball-like shape that extends into and pivots within the opening of the lid.

The stir stick 10 can be formed of plastic, such as by injection molding. Various parts of the stir stick can be molded separately, or in separate mold cavities, and attached together, such as with adhesive or sonic welding.

As stated above, the stir stick 10 can be used with a food mixer 14. Referring to FIG. 6, the food mixer 14 can include a goblet 40 or container to receive the food and/or liquid for mixing or blending. The goblet 40 can be formed of glass or plastic. The goblet 10 can have an upper opening so that the goblet has an open upper end. In addition, the goblet or container wall can have a lower opening. The goblet 10 can have an inverted, substantially frusto-conical shape. The goblet wall can have a curvature, or can be arcuate. Alternatively, the goblet wall can be straight. The goblet 10 also can have a longitudinal axis that can be substantially centered in the goblet. The goblet 10 can have an annular cross-sectional shape, with the longitudinal axis substantially concentric with the annular cross-sectional shape. Alternatively, the goblet can have other cross-sectional shapes, such as rectangular or square with rounded corners.

A mixing assembly 44 can be disposed in the goblet 40, such as at the bottom. The mixing assembly 44 can include a base cap/plug to close the lower opening in the goblet. The mixing assembly 44 can be coupled to the goblet 40 such as by a threaded coupling, or a twist lock. One or more seals or rings can be disposed between the base cap/plug and the mixing assembly to form a seal so that the goblet does not leak. The mixing assembly can also include one or more blades or stirring members that are rotatable or pivotable with respect to the goblet. The mixing assembly 30 can have a rotational axis about which the blade(s) or stirring member(s) rotate or pivot. The mixing assembly 30 can be removably coupled to the goblet so that it can be removed for cleaning. Such mixing assemblies are known in the art.

A lid 46 can be disposed on the goblet 10 to resist undesired release of the contents. The lid 46 can couple to the goblet with a twist lock, threaded coupling, press-fit, snap-fit, etc. As stated above, the lid 46 can include an aperture or opening 48. The stir-stick 10 can be carried by the lid 46, and can extend through the opening 48. The handle 18 of the stir-stick can be disposed above the lid 46, and the stir portion or stem 20 can be disposed beneath the lid 46. The stir-stick 10 allows the user to stir the contents of the goblet. The lid 46 can be rigid to resist the stir-stick 10 or stem 20 from coming into contact with the blades of the mixing assembly 44.

As indicated above, the twisted stir stick 10 with a configuration as described above can advantageously provide more efficient mixing of the food and/or liquid, or contents of the goblet. In use, the stem 20 or stirring portion can be rotated or pivoted about the goblet, or around the longitudinal axis of the goblet. Referring to FIG. 8, it will be appreciated that while the stem rotates, its orientation can remain substantially the same. Thus, as the stem rotates, the broad surfaces or faces of the bottom portion 26 pushes the contents at opposite rotational positions (such as at 0 and 180 degrees), while the sides or edges of the bottom portion 26 cut through the contents at different rotational positions (such as at 90 and 270 degrees). Similarly, the broad surfaces or faces of the top portion 24 pushes the contents at the different rotational positions with respect to the bottom portion 26 (such as at 90 and 270 degrees), while the sides or edges of the top portion 24 cut through the contents at the push rotational positions of the bottom portion 26 (such as at 0 and 180 degrees). Thus, the top and bottom portions 24 and 26 each sequentially push and cut through the contents at ninety degree intervals. In addition, the top and bottom portions 24 and 26 push and cut through the contents at different rotational positions. While the top portion 24 is pushing, the bottom portion 26 is cutting, and visa versa. It is believed that the alternating pushing and cutting action of the stem, and/or the different pushing and cutting action between the upper and lower portions, provides an efficient mixing action.

Furthermore, it is believed that the twist in the stem 20 provides a rotor or propeller like action to the contents. The twist in the stem, with the oblong cross section, also provides inclined surfaces 48 (FIGS. 3 and 4) that can direct or urge the contents in an upward or downward direction depending on the rotational direction of the stem. For example, as the broad surfaces or faces of the top portion 24 push against the contents, the twist in the stem tapers backward at a lower portion thereof (or forward depending on the rotational direction) causing the contents to be pushed or urged downward (or upward depending on the rotational direction). Similarly, as the broad surfaces or faces of the bottom portion 26 push against the contents, the twist in the stem extends forward at an upper portion thereof (or rearward depending on the rotational direction) causing the contents to be pushed or urged upward (or downward depending on the rotational direction. Thus, pivoting or rotating the stem or stirring portion causes the ingredients to be urged upward and downward, facilitating mixing.

Referring again to FIG. 6, the goblet 10 can also include a spout 50, spigot or faucet to facilitate dispensing the contents. The spout 50 can be coupled near or at the bottom of the goblet, and can include a valve to selectively operate the spout, and to selectively dispense the contents. An actuator handle can be coupled to the valve to operate the valve. The valve can be disposed on a distal end of the spout.

The mixer 14 can include a base 60 having a motor 64 turning a drive mechanism 68 extending from the base to engage the mixing assembly 44. The goblet 10 is disposable on the base 60 with the drive mechanism engagable with the mixing assembly. A socket or receptacle can be formed on the top of the base to receive the base cap/plug of the goblet. The socket or receptacle can hold the goblet as the mixing assembly and drive mechanism rotate. The goblet 10 can be removably disposed on the base. The mixing assembly and the drive mechanism can include intermeshing members to transmit rotational force from the drive mechanism to the mixing assembly.

A cup indentation 80 can be formed in the base 60 at a position underneath the spout 50 with the goblet disposed on the base. The cup indentation extends into the base, and can extending vertically downward from the spout through a bottom of the base, so that the base is open to a support surface upon which the base is disposed at the cup indentation. A pair of protrusions 84 can extend from the base on each side of the cup indentation. The protrusions 84 can help stabilize the base when the valve or spout is actuated. The protrusions can extend substantially the height of the base, as shown in phantom lines, or can be less than the height of the base, as shown in solid lines. The shorter protrusions can cause less interference with the operation of the valve or spout. The cup indentation can be defined between the protrusions.

Various aspects of smoothie makers and/or beverage mixers are described in U.S. Pat. No. 6,527,433; and U.S. patent application Ser. No. 10/278,713, filed Oct. 23, 2002; which are herein incorporated by reference.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A stir-stick configured for use with a food mixer, the device comprising:
a) a handle configured to be gripped by a user;
b) an elongated stem, coupled to the handle, defining a stirring portion and having a longitudinal axis and an oblong cross-sectional shape, the stem extending along the longitudinal axis and outwardly from the longitudinal axis such that the longitudinal axis is substantially within the stem; and
c) the stem extending through a twist that twists from an upper portion to a lower portion with an upper cross-sectional shape and a lower cross-sectional shape having different rotational orientations about the longitudinal axis with respect to one another.

2. A device in accordance with claim 1, further comprising an enlarged stopper disposed between the handle and the stem configured to abut a lid of the food mixer.

3. A device in accordance with claim 2, wherein the enlarged stopper has a downward facing curved face configured to pivot in an opening in the lid of the food mixer.

4. A device in accordance with claim 1, wherein the twist is continuous and uninterrupted from the upper portion to the lower portion.

5. A device in accordance with claim 1, wherein the upper and the lower cross-sectional shapes are oriented at about 90 degrees about the longitudinal axis with respect to one another.

6. A device in accordance with claim 1, wherein the upper and lower portions define planes oriented transverse with respect to one another and intersecting one another at the longitudinal axis.

7. A device in accordance with claim 1, wherein the longitudinal axis of the stem is disposed substantially at a center of the stem; and wherein the twist has a twist axis about which the stem twists; and wherein the longitudinal axis and twist axis are collinear.

8. A device in accordance with claim 1, further comprising:
a) a container;
b) a mixing assembly, disposable in the container; and
c) a lid, disposable on the container, having an aperture therein; and
d) the stem being disposable through the aperture in the lid and into the container.

9. A device in accordance with claim 8, further comprising:
a spout, operatively coupled to the container, and having a valve operable to selectively dispense contents of the container.

10. A device in accordance with claim 8, further comprising:
a base having a motor capable of turning a drive mechanism extending therefrom, the container being disposable on the base with the drive mechanism engagable with the mixing assembly.

11. A device in accordance with claim 10, further comprising:
a cup indentation formed in the base, the cup indentation extending into the base and extending through a bottom of the base; and
a pair of protrusions, extending from the base with the cup indentation therebetween.

12. A food mixer device, comprising:
a) a container;
b) a lid, disposable on the container, and having an aperture therein; and
c) a stir-stick, extendable through the aperture in the lid and carriable by the lid, the stir stick including:
i) a handle, disposable above the lid, configured to be gripped by a user;
ii) an elongated stem, coupled to the handle and extendable into the container, the stem defining a stirring portion and having a longitudinal axis and an oblong cross-sectional shape, the stem extending along the longitudinal axis and outwardly from the longitudinal axis such that the longitudinal axis is substantially within the stem; and
iii) the stem extending through a twist that twists from an upper portion to a lower portion with an upper cross-sectional shape and a lower cross-sectional shape having different rotational orientations about the longitudinal axis with respect to one another.

13. A device in accordance with claim 12, further comprising an enlarged stopper disposed between the handle and the stem, and abutting the lid.

14. A device in accordance with claim 13, wherein the enlarged stopper has a downward facing curved face pivotable in the aperture in the lid.

15. A device in accordance with claim 12, wherein the twist is continuous and uninterrupted from the upper portion to the lower portion.

16. A device in accordance with claim 12, wherein the upper and the lower cross-sections are oriented at about 90 degrees about the longitudinal axis with respect to one another.

17. A device in accordance with claim 12, wherein the upper and lower portions define planes oriented transverse with respect to one another and intersecting one another at the longitudinal axis.

18. A device in accordance with claim 12, wherein the longitudinal axis of the stem is disposed substantially at a center of the stem; and wherein the twist has a twist axis about which the stem twists; and wherein the longitudinal axis and twist axis are collinear.

19. A device in accordance with claim 12, further comprising:
a mixing assembly, disposable in the container.

20. A device in accordance with claim 12, further comprising:
a spout, operatively coupled to the container, and having a valve operable to selectively dispense contents of the container.

21. A device in accordance with claim 12, further comprising:
a base having a motor capable of turning a drive mechanism extending therefrom, the container being disposable on the base with the drive mechanism engagable with the mixing assembly.

22. A device in accordance with claim 21, further comprising:
a cup indentation formed in the base, the cup indentation extending into the base and extending through a bottom of the base; and
a pair of protrusions, extending from the base with the cup indentation therebetween.

23. A stir-stick configured for use with a food mixer, the device comprising:
a) a handle configured to be griped by a user;
b) an elongated stem, coupled to the handle, defining a stirring portion and having a longitudinal axis and an oblong cross-sectional shape, the stem extending along the longitudinal axis and outwardly from the longitudinal axis such that the longitudinal axis is substantially within the stem;
c) an enlarged stopper, disposed between the handle and the stem, configured to abut a lid of the food mixer; and
d) the stem extending through a twist that twists from an upper portion to a lower portion with an upper cross-sectional shape and a lower cross-sectional shape having different rotational orientations about the longitudinal axis with respect to one another.
